(19) United States
(12) Patent Application Publication
(10) Pub. No.: US 2026/0317050 A1
(43) Pub. Date: Oct. 15, 2026

(54) BEVERAGE OR FOODSTUFF PREPARATION SYSTEM

(71) Applicant: SOCIÉTÉ DES PRODUITS NESTLÉ S.A., Vevey (CH)

(72) Inventors: André NOTH, Pully (CH); Arnaud GERBAULET, Oye et Pallet (FR); Carlo MAGRI, Monthey (CH); Emmanuel CROISIER, Lonay (CH); Cécile DONIER, Vaux et Chantegrue (FR); Ricardo MANTINHA GOMES, Cugy (CH); Szabolcs BALASI, Pully (CH); Matteo Yann FEO, Puidoux (CH); Jean-Christophe GUILLAUD-BATAILLE, Aubonne (CH)

(21) Appl. No.: 19/116,652

(22) PCT Filed: Oct. 3, 2023
(86) PCT No.: PCT/EP2023/077351

§ 371 Date: Mar. 28, 2025

(30) Foreign Application Priority Data
Oct. 3, 2022 (EP) 22199334.8

(51) Int. Cl. B65D 85/804; A47J 31/44

(52) U.S. Cl. CPC B65D 85/8058; A47J 31/4492; B65D 2203/06

(57) ABSTRACT

A container for use with a beverage or foodstuff preparation machine, the container comprising: a storage portion for containing a precursor material; a code storing preparation information used by said machine to process the precursor material, the code readable by a code reading system of the machine, which comprises: a lighting system to project an emission of greater than 700 nm or 800 nm to the code, and a camera system for obtaining a digital image of the code operating with a wavelength of above or 700 nm or 800 nm, the code is arranged to absorb and/or reflect the emission for capturing in a digital image by said camera system, and; an information carrier layer comprising container information that is visible in visible wavelengths, and has comparatively low absorbance and/or reflectivity to said emission, wherein the information carrier layer is arranged in operative proximity to the code layer to conceal the code.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

EP 2594171 A1 discloses a machine that reads a code from an underside of a flange of a capsule. A drawback is that the code cannot be applied to parts of the capsule that are more flexible, e.g. the closing member, since the code can only be read from a rigid support. Moreover, the code is configured for reading based on it being formed on an optically opaque carrier material.

Therefore, in spite of the effort already invested in the development of said systems further improvements are desirable.

### SUMMARY

The present disclosure provides a container for use with a machine for preparing a beverage and/or foodstuff. In embodiments, the container includes a body portion comprising a storage portion for containing a precursor material.

In embodiments, the container incudes a closing member to close the storage portion (e.g. for a container arranged as a capsule). In embodiments, the closing member overlaps the precursor material contained in the storage portion. As used herein, the term “overlap” in respect of the closing member and the precursor material, may refer to a plane of the closing member having a normal thereto that intersects the precursor material. For example, the normal may be in a depth direction and the closing member may extend on a plane defined by lateral and longitudinal directions. In embodiments, the storage portion includes a cavity that extends in a depth direction from the closing member. In embodiments, the body portion includes a flange portion that connects the storage portion to the closing member. In embodiments, the flange portion and/or closing member extends in a plane defined by a lateral and a longitudinal direction. The cavity of the storage portion extends in a depth direction from the flange. In embodiments, the flange is planar. As used herein the term “planar” in respect of the flange may refer to the flange arranged to extend entirely with the lateral and longitudinal directions, or substantially with said directions (e.g. with major components in these directions as opposed to a depth direction).

In embodiments, the body portion is formed of walls that are joined at seams and/or folded (e.g. for a container arranged as a packet).

The container comprises a code for (e.g. configured for) storing preparation information. The preparation information may be used by said machine to process the precursor material. In embodiments, the code is configured to be readable by a code reading system of the machine, which comprises: a lighting system to project an emission the code for reading (e.g. by illumination), and may include; a camera system, (e.g. for obtaining a digital image of the code when subject to said emission). The preparation information may be related to the container, e.g. it is selected to correspond to the precursor material and/or the container dimensions, such that a processing unit of the machine can be controlled in a specifically adapted process for the particular container. In embodiments the closing member comprises the code, e.g. formed as one or more layers thereof. As used herein the term “code” may refer to one or a plurality of repetitions of codes that each store the preparation information and are separately readable. In embodiments, the code and associated layers extend in a plane defined by a lateral and a longitudinal direction and have a through thickness in a depth direction.

In embodiments, the code is arranged to overlap the precursor material (e.g., a normal to a plane in which the code is arranged extends into the precursor material, such that an emission from the lighting system projects into the precursor material). For example, it is arranged on the closing member or is arranged on a wall of the packet. In embodiments, the code arranged not to overlap the precursor material. For example, it is arranged on a flange portion or a seam of the packet. In embodiments, the emission from the lighting system has a wavelength of greater than 700 nm or 800 nm. The emission may be substantially in the infra-red wavelengths. The emission may have a peak of any value between 800-1000 nm, with a HWHM of ±100 or 50 or 25 nm. The camera system may be correspondingly configured to obtain a digital image within said wavebands. The camera system may comprise a high pass filter to pass wavelengths above 700 nm or 800 nm. The emission and/or camera system may operated with a maximum wavelength of 1200 nm or 1500 nm

### Support Layer Which is Transparent to Emission

In embodiments, the container comprises a support layer to support the code. In embodiments, the support layer at least partially transparent (e.g. to light) to the emission from the lighting system (e.g. such that some or all the emission may pass through the support layer). In embodiments, the code comprises: an absorber layer, which is configured to absorb the emission, and; a reflector layer, which is configured to reflect the emission, the reflector layer is arranged to reflect the emission before it is transmitted to the support layer.

By implementing a transparent support layer, the support layer may be thin such that it is able to support the layers forming the closing member whilst being penetrable by the machine (for processing of the precursor material) and/or the support layer may be made of a biodegradable material (which is commonly optically transparent). Examples, include paper or a biodegradable plastic. The reflector layer may compensate for the transparency of the support layer by reflecting the emission before it reaches the support layer, whereas the absorber layer may absorb the emission, the combination of both layers permitting a units of the code to be identified against a contrasting background. In an example without a reflector layer, the emission may otherwise be transmitted through the support member and be absorbed by the precursor material, which may not enable suitable contrast with the absorber layer.

In embodiments, the reflector layer is continuous. By implementing reflector layer that is arranged as one piece (e.g. over an area that comprises the absorber layer) a large uniform reflection of the emission below the absorber layer may be by achieved, which may improve readability of the code.

In embodiments, the reflector layer is connected (including directly or via an adhesive or other connection) to the support layer to adjoin the support layer. By connecting the reflector layer to the support layer, it may be ensured that the emission is reflected before it is transmitted through the support layer.

In embodiments, the support layer extends in a plane defined by lateral and longitudinal directions and has a through thickness in a depth direction, the depth direction extending from an outer surface (e.g. an outer surface of the closing member or in other embodiments the portion of the container comprising the code). The outer surface may comprise an exposed surface of a protective layer, or in embodiments without a protective layer the code, comprise an exposed surface of the absorber layer.

In embodiments, the reflector layer is arranged to overlap the entire the support layer when viewed in said plane. By arranging the reflector layer to overlap the entire support layer (e.g. in an area that comprises the absorber layer of the code) it may be ensured that the emission is reflected before it is transmitted through the support layer.

In embodiments, the absorber layer is arranged in the depth direction between the reflector layer and the outer surface, such that the absorber layer is proximal most the outer surface relative to the reflector layer and the reflector layer is arranged in the depth direction between the support layer and the outer surface. By arranging the absorber layer closest to the outer surface, it may absorb the emission uninterrupted by the reflector layer, with the reflector layer arranged to subsequently reflect the emission and prevent its absorption by the support layer and/or precursor material.

In embodiments, the portion of the container comprising the support layer and code (and other layers when present, including the barrier layer and protective layer—e.g. an entire closing member) is configured to be penetrable by a one or more penetrators, each with a tip angled at 70-30 degrees, when subject to a force of greater than a threshold. The tip may have a full round applied, with a radii to correspond to the tip angle. The threshold force may be 7-10 N or 5-15 N per penetrator. Alternatively, the threshold maybe a total force of 700 N (±20% or ±30%) applied to all the penetrators, e.g. there may be a total of 88 or 50-150 penetrators.

By implementing penetrating at said threshold, the support layer can be penetrated by the machine during processing, but is not accidentally penetrated when subject to handing. In embodiments, the support layer is the primary support layer, e.g. it is able to resist a higher tensile strength than the other layers. In embodiments, the support layer has a thickness of 50 to 150 microns.

In embodiments, the support layer is transparent to at least 30-80% of the emission from the lighting system. With said transparency to the emission, the support layer may be thin such that it is penetrable by the machine and/or biodegradable. In embodiments, the precursor material is absorbent to at least 60% of the emission from the lighting system. Embodiments, the support layer comprises one or more of: paper based; aluminium based; plastic based.

In embodiments, the absorber layer comprises carbon and the reflector layer does not comprise carbon. The support layer may also not comprise carbon. In embodiments, the absorber layer is formed of a black ink that comprises carbon and the reflector layer is formed of one or more inks that do not comprise carbon, e.g. a white ink. By using carbon as the absorber, and its absence as the reflector, the code may be conveniently read in the infrared spectrum. The layers may also be conveniently formed using ink by printing.

In embodiments, the reflector layer is configured to diffusively reflect the emission. The reflectance to the emission may be at least 70%. By diffusively reflecting the light, a convenient homogeneous background (e.g. white) for the code may be provided (since the alternative of specular reflection may be readable as spots of saturated white). In embodiments, the absorber layer has a reflectance of less than 10%. A low reflectance compared to the reflector layer may provide adequate contrast between the layers when reading the code. In embodiments, a thickness of the absorber layer and/or reflector layer is 1-5 micron.

### Support Layer With Specular Reflection

In embodiments, the support layer is configured for specular reflection of the emission from the lighting system, and the code comprises: an absorber layer, which is configured to absorb the emission and a reflector layer, which is configured to diffusively reflect the emission, the reflector layer arranged to reflect the emission before it is transmitted to the support layer.

By implementing the support layer for specular reflection (e.g. such that at least 50% or 70% or 80% of the light reflected from the support layer is reflected as specular), a particular surface finish may be provided. Said specular reflection may also luminate the code for improved reading, however the reflector layer may reflect most of the emission before it is transmitted to the support layer and also reflect any of the emission that is reflected from the support layer such that the code reader does not see the specular reflection, which may otherwise cause saturation of the digital image of the code. Specular reflection may be achieved by a particular smoothness or other surface finish, e.g., aluminium or other polished/smooth metal.

In embodiments, the reflector layer is continuous, the reflector layer is connected to the support layer to adjoin the support layer, and; the support layer extends in a plane defined by lateral and longitudinal directions and has a through thickness in a depth direction, and where the reflector layer to overlap the entire the support layer when viewed in said plane.

In embodiments, the support layer extends in a plane defined by lateral and longitudinal directions and has a through thickness in a depth direction, the depth direction extending from an outer surface, and: the absorber layer is arranged in the depth direction between the reflector layer and the outer surface, such that the absorber layer is proximal most the outer surface relative to the reflector layer, and; the reflector layer is arranged in the depth direction between the support layer and the outer surface. In embodiments, the absorber layer is arranged to overlap the entire the reflector layer when viewed in said plane.

In embodiments, the support layer is configured to provide at least 60% or 80% or 90% of a tensile strength of the associated laminate that includes the support layer, the reflector layer and the absorber layer (and any other layers that may optionally be present, e.g. a protective layer and a barrier layer). By implementing the support layer to provide a primary structural support in tension compared to the other layers that are present, the support layer may provide structural strength to resist accidental penetration by handling and a suitable support to enable reading of the supported code, e.g. without distortion. In embodiments, the support layer has a thickness of 2 to 50 microns or 5 to 10 microns.

In embodiments, the support layer has a reflectance of at least 70%. By implementing the support layer to reflect a substantial amount of the incident emission, it may illuminate the code for more convenient reading. In embodiments, the support layer is optically opaque.

In embodiments, the reflector layer is configured to diffusively reflect the emission. The reflectance to the emission may be at least 70% or 80%. By diffusively reflecting the light, a convenient homogeneous background (e.g. white) for the code may be provided (since the alternative of specular reflection may be readable as spots of saturated white). In embodiments, the absorber layer has a reflectance of less than 10%. A low reflectance compared to the reflector layer may provide adequate contrast between the layers when reading the code. In embodiments, a thickness of the absorber layer and/or reflector layer is 1-5 micron. The reflector layer may have a white surface. The reflector layer may be configured for diffuse reflection, e.g. with a surface finish to reflect the wavelengths of the emission diffusely, e.g. a rough, matte surface.

In embodiments, the reflector layer is configured to diffusively reflect the emission. At least 60% or 70% tor 80% of the emission maybe reflected as diffuse light. The diffuse light may be defined as light which is substantially uniform in intensity due to scattering cause by a surface of the reflector layer.

In embodiments, the reflector layer may be partially to the emission, including transparent to less than 20% or 30% of the emission, including with an optional minimum transparency of 5% or 10%. By enabling a portion of the emission to be transmitted through the reflector layer said transmission may be conveyed to the support layer. For a specular support layer such a transparency may enable a surface finish of the support layer to be observed though the code. Sain transparency can be obtained with the white ink printing.

In embodiments, the absorber layer has a reflectance of less than 10% or 30%.

In embodiments, the support layer is aluminium based. An aluminium support layer may be food safe and/or provide a barrier to moisture and/or oxygen. Aluminium based may include an aluminium polymer, e.g. including PET12u/Alu30/BOPP30

### Precursor Material as Absorber Layer

In embodiments, the container comprises the code arranged to overlap the precursor material, and; a support layer to support the code, the support layer at least partially transparent to the emission from the lighting system, wherein the code comprises reflector layer, which is configured to reflect the emission before it is transmitted to a support layer, and the precursor material is arranged to absorb the emission.

By implementing a support layer that is transparent to the emission and the precursor material to absorb said emission, the precursor material may be visible in a digital image as a dark surround, with the reflector layer forming units of the code, which are visible as light areas on the dark surround. A dedicated absorber layer in the code, or other component of the container (e.g. the closing member) may be obviated, which may make the code more convenient to form.

In embodiments, the precursor material is absorbent to at least 60% of the emission from the lighting system. By implementing the precursor material to absorb most, e.g. above 50% or 70%, of the emission the precursor material may provide a uniform, relatively dark background in the image.

In embodiments, the precursor material comprises ground coffee. Ground coffee has been found to have a high absorbance of the selected wavelengths of the emission disclosed herein due to its high carbon content.

In embodiments, the reflector layer is configured to diffusively reflect the emission. By implementing the reflector to substantially diffusely reflect the emission, the units of the code may be precisely readable, e.g. as opposed to specular reflection which may cause saturation in the digital image. The diffusive reflection may be uniform over the reflector layer, including with minimal specular reflection (e.g. less than 10% or 5% is specular reflection).

In embodiments, the reflector layer is configured with a reflectance to the emission of at least 60% or 70% or 80%. By implement the reflector layer to have a comparatively high reflectance to the precursor material, there may be suitable contrast between the reflector layer and precursor material in the image.

In embodiments, the reflector layer is formed of one or more inks that do not comprise carbon and the precursor material comprises carbon. By implementing the reflector layer so as not to comprise carbon, the presence of carbon in the precursor material may be exploited to improve contrast of the reflector layer when subjected to the emission of the light source with a wavelength of greater than 700 nm or 800 nm and the camera system is arranged sense light of said wavelength.

### Information Carrier Layer

In embodiments, the code is readable by a code reading system of the machine, which comprises: a lighting system to project an emission of greater than 700 nm or 800 nm to the code, and a camera system for obtaining a digital image of the code operating with a wavelength of above or 700 nm or 800 nm, the code is arranged to absorb and/or reflect the emission for capturing in a digital image by said camera system, and; an information carrier layer comprising container information that is visible in visible wavelengths, and has comparatively low absorbance and/or reflectivity to said emission, wherein the information carrier layer is arranged in operative proximity to the code layer to conceal the code. The container information of the information carrying layer may be arranged to be readable by a user.

By implementing the code to be readable in the substantially infra-red wavelengths (e.g. above 700 nm and may be up to 100 um) the reading of the code may not be interfered with by the information carrier layer, which is visible in visible wavelengths (e.g. 380-700 nm) but does not absorb (including substantially absorb) or reflect (including substantially reflect) said wavelengths. Moreover, since the information carrier layer is visible in the visible waveband, it may be used to present information to the user, whilst reducing visibility of the code in the visible wavebands.

As used herein the term “container information” may refer to information related to the container and/or the precursor material, e.g. it may comprise one or more of: an identifier used by the user to identify the container or the beverage prepared therefrom; information that a user may use to select an operating parameter of the machine, e.g. a portion of milk and/or milk conditioning parameters, or a volume of water that the container requires (and which must be present in the machine) for the preparation process, or a volume of beverage prepared so that a user may select an appropriate cup size; information to identify a manufacturer of the container; expiry information, and; other information. The container information of the information carrying layer may be arranged to be readable by a user.

As used herein the term “operative proximity” may refer to a positional arrangement of the information carrying layer and code such that the code is concealed, or partly concealed, by the information carrying layer, it may include one or more of: overlapping when viewed normal to a plane the code is arranged on (which may include above or below the code with respect to an exterior surface of the layers), and; contiguous, e.g. in close proximity (including within 10 or 30% of a side length or a diameter of the code) to or touching.

As used herein the term “conceal the code” may refer to the information carrying layer being arranged to reduce visibility of the code in the visible wave bands (wavelengths) compared to the code being present without the information carrying layer, this may be achieved by the objects of the information carrying layer having a characteristic dimension (which may be a largest dimension of the object) at least 2-10 times that of a characteristic dimension of the code (which may be a side length or a diameter of the code). The characteristic dimension of the object may be a maximum of 30 that of a characteristic dimension of the code.

In embodiments, code is not readable in visible wavelengths due to the presence of the information carrier layer in the digital image. Such an arrangement may define the code as being concealed.

In embodiments, the information carrier layer has an absorbance to the emission of less than 20% and a reflectivity of less than 30% to said emission. By implementing the information carrier layer to have said low absorbance and low reflectance to the emission and/or the wavelengths the camera system operates in, the information carrier layer may have reduced/no appearance in the digital image and therefore low/no interference with the code reading.

In embodiments, the information carrier layer is continuous. By implementing an information carrier layer that is arranged as one piece (e.g. over an area that comprises the absorber layer) an information carrying capacity may be large, whilst conveniently concealing the code. In embodiments, the information carrier layer adjoins the code. By implementing the information carrier layer to directly adjoin the code (e.g. the absorber layer and or the reflector layer thereof) it may suitably conceal the code.

In embodiments, the information carrier layer extends in a plane defined by lateral and longitudinal directions and has a through thickness in a depth direction, which extends from an outer surface. In embodiments, the information carrier layer is arranged to overlap the entire code when viewed in said plane. By implementing the information carrier layer to overlap the code (e.g. the absorber layer and or the reflector layer thereof) it may suitably conceal the code.

In embodiments, the code (e.g. an absorber layer thereof) is proximal most the outer surface relative to the information carrier layer. By arranging the code (e.g. the absorber layer) closer to the outer surface than the information carrier layer, the code may be read with minimal interference from the information carrier layer.

In embodiments, the code comprises an absorber layer, which is configured to absorb the emission and a reflector layer, which is configured to reflect the emission; the reflector layer is configured to reflect visible wavelengths; the information carrier layer is arranged in a depth direction between the reflector layer and an outer surface of the closing member, and; the absorber layer is arranged in a depth direction between the reflector layer and an outer surface of the closing member. By implementing the reflector layer to reflect visible wavelengths (as well as those of the emission from the lighting system), including all visible wavelengths such that it appears white, a uniform background may be provided for the information carrier layer to be observed on.

In embodiments, the reflector layer extends in a plane defined by the lateral and longitudinal directions and has a through thickness in a depth direction, and: the reflector layer is continuous and overlaps the information carrier layer in said plane.

In embodiments, the information carrier layer comprises the one or more objects providing said information. Said objects may be formed of one or more different colours. Said objects may provide information to a user whilst concealing the code. Multiple colours (e.g. formed from inks of cyan, magenta and yellow) may increase the information carrying capacity.

In embodiments, the container comprises a colour layer arranged to impart a background colour. In embodiments, the colour layer is arranged in a depth direction between the reflector layer and an outer surface. In embodiments, the colour layer is arranged in a depth direction between the reflector layer and the information carrier layer. With such an arrangement the colour layer may impart a background colour (e.g. brown) to the information carrier layer other than that of the reflector layer (which maybe white). In embodiments, the colour layer is continuous (e.g. one piece over the reflector layer and/or the information carrier layer). In embodiments, the colour layer is formed of one or more inks that do not comprise carbon. In embodiments, the information colour layer is arranged to overlap the entire information carrier layer when viewed in said plane.

In embodiments, the container comprises a protective layer through which the code is readable by the code reading system. In embodiments, the protective layer is transparent (including substantially transparent) to the emission from the lighting system and said emission reflected from the reflector layer.

The embodiments, the protective layer is moisture and/or oxygen resistant. By implementing the protective layer to provide a moisture and/or oxygen barrier, the code may be protected from degradation and/or may be ensured as food safe.

In embodiments, the protective layer comprises a formed of regenerated cellulose, e.g. cellophane DN22. A regenerated cellulose may be biodegradable whilst being food safe and suitably optically transparent.

In embodiments, the code (e.g. the absorber layer and/or the reflector layer) is formed by printing on (including directly on or via an intervening layer) the protective layer. By directly printing layers of the code onto the protective layer with printing apparatus, the closing member (or in other embodiments other portion of the container comprising the code) may be conveniently formed with high precision.

In embodiments, the container comprises a barrier layer, which is arranged to bound the precursor material, wherein the barrier layer is moisture and/or oxygen resistant and may comprise a biodegradable polymer. The barrier layer may provide isolation of the precursor material from the support layer and/or other constituent layers, which may improve food safety and/or improve longevity of said layers.

In embodiments, the container (e.g. the closing member thereof or in other embodiments the portion of the container comprising the code) is biodegradable as defined with reference to as defined by EN 13432:2000 (including anaerobic conditions, disintegration etc) and/or EN 14046:2004 (aerobic conditions).

In embodiments, the container of any preceding claim, wherein the material on which the code is formed (e.g. the closing member) has a total thickness of 100 to 250 microns.

### System

The present disclosure provides system comprising the container of any preceding embodiment or another embodiment disclosed herein and a machine for preparing a beverage or a foodstuff by processing said precursor material, the machine comprising: a code reading system to read said code; a processing unit for processing the material of the container to the beverage or foodstuff, and electrical circuitry to control the processing unit to process the container based on the preparation information.

In embodiments, the processing unit comprises a perforator to perforate the code bearing portion of the container (e.g. closing member of the container). In embodiments, the perforator is an injector to inject liquid into the container. In embodiments, the perforator used to provide an outlet for the beverage or foodstuff from the container.

The present disclosure provides a closing member for closing a storage portion of a container for use with a beverage or foodstuff preparation machine, the closing member comprising the code and associated layers of any preceding embodiment or another embodiment disclosed herein.

The present disclosure provides use of the closing member of any preceding embodiment or another embodiment disclosed herein for a container containing precursor material for use with a beverage or foodstuff preparation machine.

### Method of Forming

The present disclosure provides a method of forming a container (e.g. a closing member thereof or a wall of a packet) with a code for use with a beverage or foodstuff preparation machine. The method may implement the features of any other embodiment or another embodiment disclosed herein.

In embodiments, the method comprises: printing a code on a protective layer through which the code is readable by a code reading system, the code comprising an absorber layer, which is configured to absorb an emission from the code reading system and a reflector layer, which is configured to reflect (e.g. diffusively) the emission, the reflector layer arranged to reflect the emission before it is transmitted to a support layer, and; connecting the layers to the support layer, which is at least partially transparent to the emission. In embodiments, the support layer is configured for specular reflection of the emission from the lighting system. In embodiments, the support layer is configured to be substantially transparent to the emission from the lighting system.

In embodiments, the method comprises: printing a code on a protective layer through which the code is readable by a code reading system, the code comprising a reflector layer, which is configured to reflect an emission from the code reading system, the reflector layer arranged to reflect the emission before it is transmitted to a support layer, and; connecting the layers to the support layer, which is at least partially transparent to the emission or which is configured for specular reflection of the emission from the lighting system.

In embodiments, the method comprises: printing a code on a protective layer through which the code of a code is readable by a code reading system, the code layer is arranged to absorb and/or reflect the emission for capturing in a digital image by the camera system operating with a wavelength of above or 700 nm or 800 nm, printing an information carrier layer on to the protective layer, wherein the information carrier layer is arranged to conceal the code, the information carrier layer, comprising container information that is visible in visible wavelengths, and has comparatively low absorbance and/or reflectivity to said emission, and; bonding the layers to a support layer.

In embodiments, the method comprises arranging one or more of: the code; the protective layer; the information carrier layer, and; the support layer, over the precursor material (e.g. in an overlapping manner, e.g. by closing a storage portion).

### Method of Reading

The present disclosure provides a method of reading preparation information from a code of a container containing precursor material. The method may implement the features of any other embodiment or another embodiment disclosed herein.

In embodiments, the method comprises: absorbing with an absorber layer of the code an emission of a lighting system of a code reading system; reflecting (e.g. diffusively) said emission with a reflector layer of the code, such that either the emission is at least partially attenuated through a support layer, which is at least partially transparent to said emission or the emission is at least partially attenuated to a support layer, which configured for specular reflection; obtaining a digital image of the code layer with a camera system of the code reading system, and; processing the digital image to extract said preparation information.

In embodiments, the method comprises: reflecting an emission of a lighting system of a code reading system with a reflector layer of the code, such that the emission is at least partially attenuated through a support layer, which is at least partially transparent to said emission; absorbing the emission transmitted through the support layer with the precursor material; obtaining a digital image of the code layer with a camera system of the code reading system, and; processing the digital image to extract said preparation information.

In embodiments, the method comprises: absorbing and/or reflecting with a code an emission for a lighting system of a code reading system with a wavelength of above or 700 nm or 800 nm, avoiding reflecting or absorbing said emission with an information carrier layer, comprising container information that is visible in visible wavelengths, obtaining a digital image of the code layer with a camera system operating above or 700 nm or 800 nm, and; processing the digital image to extract said preparation information.

The method of reading preparation information from the code may be implemented as part of a method of preparing a beverage or foodstuff, the method comprising: controlling a processing unit of a beverage or foodstuff preparation machine to process the container based on the determined preparation information. The method may comprise perforating the code bearing portion of the container (e.g. a support layer of the closing member) with a perforator of a beverage or foodstuff preparation machine and injecting fluid into a storage portion of the container containing precursor material.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff.

FIG. 2 is a block system diagram showing an embodiment machine of the system of FIG. 1.

FIG. 3 is an illustrative diagram showing an embodiment fluid conditioning system of the machine of FIG. 2.

FIGS. 4 and 5 are illustrative diagrams showing an embodiment container processing system of the machine of FIG. 2 on open and closed positions.

FIG. 6 is a block diagram showing embodiment control electrical circuitry of the machine of FIG. 2.

FIG. 7 is an illustrative diagram showing an embodiment container of the system of FIG. 1.

FIG. 8 is flow diagram showing an embodiment preparation process, which is performed by the system of FIG. 1.

FIG. 9 is a plan view showing an embodiment code of the containers of the system of FIG. 1.

FIGS. 10 and 11 are flow diagrams showing embodiment processes for extracting preparation information from the code of FIG. 9.

FIGS. 12-14, 18 and 19 are illustrative diagrams showing an embodiment materials for the container of FIG. 7.

FIGS. 15, 16 and 17 are images provided by a code reding system of the code of the closing member of FIGS. 12-14.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. For convenience, a machine that prepares a beverage and/or foodstuff can also refer to the preparation of a precursor for a beverage and/or foodstuff prepared from a pre-precursor material. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process, and; it is biodegradable. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid (e.g. a solid suspended in a liquid); a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reading system. The code reading system may provide a bit stream signal or a high and low signal for processing by preparation information extraction. The code may be arranged as a two dimensional code, which is processed via a digital image obtained from a camera system of the code reading system. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; agitation (e.g. frothing degree); any of the aforesaid defined for one or more phases, wherein the preparation process is composed of a series of sequential, discrete phases. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### General System Description

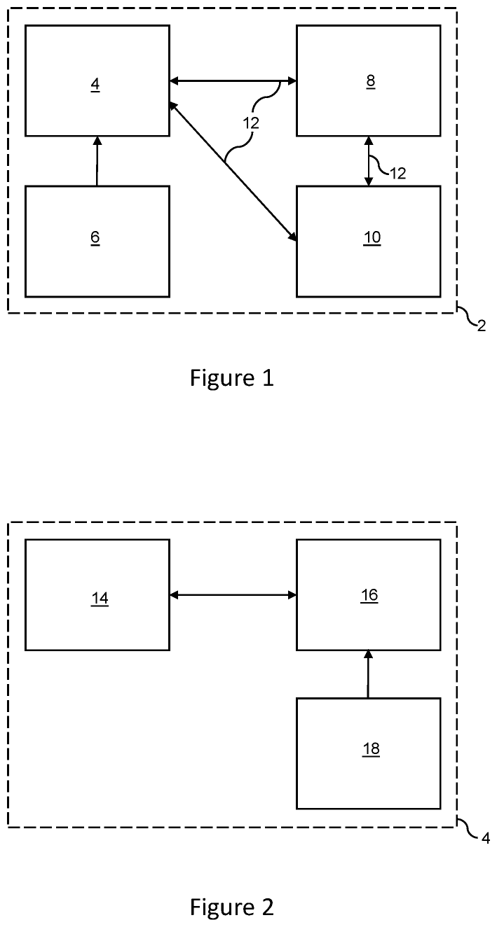

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth ™ protocol, and; the server system communicates with the machine via a via a wireless interface, e.g. with a IEE 802.11 standard, and also via the internet.

### Machine

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### First Example of Processing Unit

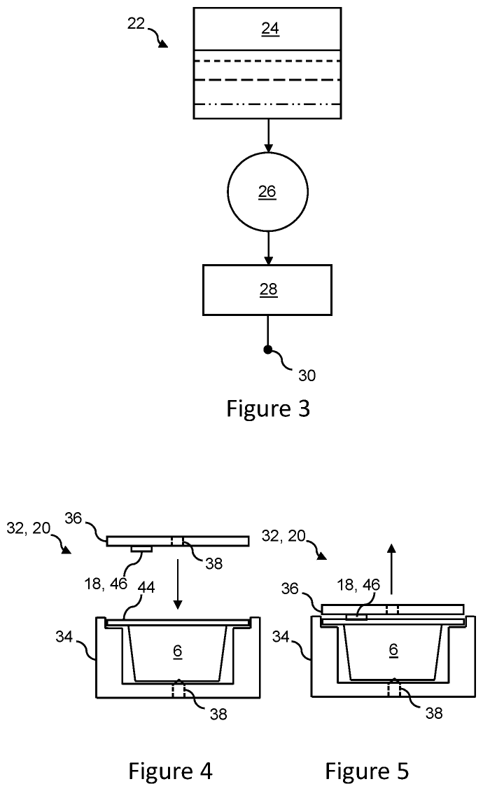

Referring to FIGS. 3, 4 and 5, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### Fluid Conditioning System

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump; the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### Container Processing Unit

The container processing unit 20 can be implemented with a range of configurations, as illustrated in examples 1-6 below. Generally, in examples where the machine 2 comprises a guide portion, in to which a container is inserted and is guided by gravity (e.g. under its own weight) to the container processing unit 20, the container processing unit 20 is arranged with a container holding portion and a closing portion, which are movable between a container receiving position and a container processing position in a depth direction, which is perpendicular (including substantially perpendicular) to a direction of transmission of the guide portion.

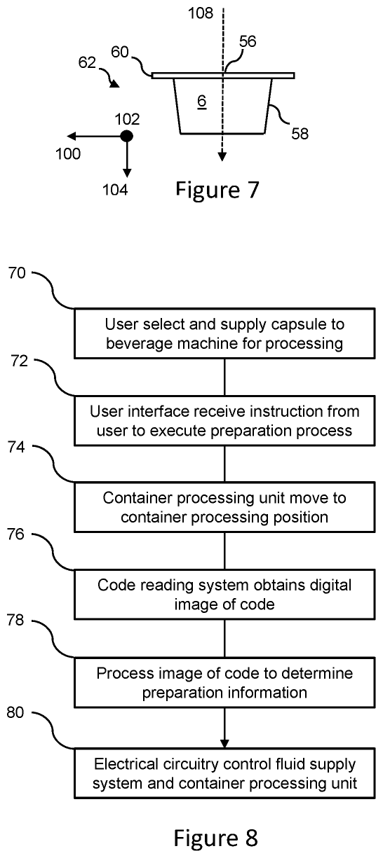

Referring to FIGS. 4 and 5, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4), in which capsule holding portion 34 and a closing portion 36 are arrange to receive a capsule 6 therebetween. The extraction unit 32 is movable to a capsule extraction position (FIG. 5), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 on the capsule holding portion 34 to inject the conditioned fluid into the capsule 6 in the capsule extraction position, typically under high pressure. A beverage outlet 40 on the closing portion 36 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C) fluid to the precursor material within the capsule 6. The pressure is increased over a predetermined amount of time until a pressure of a rupturing portion (not illustrated in FIGS. 4 and 5) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the capsule holding portion and closing portion, they may be alternatively arranged, including: the injection head and beverage outlet are arranged respectively on the closing portion capsule holding portion and; or both on the same portion. Moreover, the extraction unit may include both parts arranged as a capsule holding portion, e.g. for capsules that are symmetrical about the flange, including a Nespresso® Professional capsule. Examples of suitable extraction units are provided in EP 1472156 A1 and in EP 1784344 A1 and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1. With such an example (or indeed the other examples) a guide portion may be obviated and the container manually loaded into the extraction unit.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a Nespresso® Dolce Gusto capsule. Examples of suitable extraction units are disclosed in EP 1472156 A1 and in EP 1784344 A1.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP14167344A.

### Code Reading System

Referring to FIGS. 4 and 5, the code reading system 18 is arranged to read a code 44 arranged on a lid of the container 6. The code reading system 18 is integrated with the extraction unit 32 of first example of the container processing unit 20. The code 44 is read with the extraction unit 32 in the capsule extraction position (as shown in FIG. 4).

The code reading system 18 includes a code reader 46 with an image capturing unit and a reading head housing the image capturing unit to capture a digital image of the code 44. The image capturing unit includes a lighting system and camera system. Examples of a suitable image capturing unit include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a flange or containment portion. In further variant embodiments, which are not illustrated, the code is a one dimensional code and is read by relative movement between the code reader and the code to produce a code signal.

### Control Electrical Circuitry

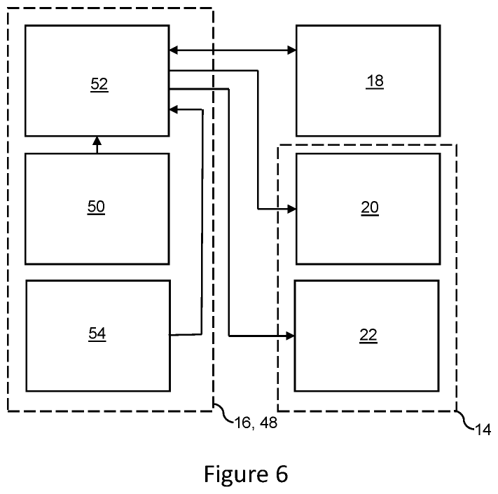

Referring to FIG. 6, the electrical circuitry 16 is implemented as control electrical circuitry 48 to control the processing unit 14 to execute a preparation process. In the embodiment of FIG. 6, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### Container

Referring to FIG. 7, a first example of a container 6, that is for use with the first example of the processing unit 14 comprises the container 6 arranged as a capsule 6. The capsule 6 includes a closing member 56 and a body portion 62, which comprises a storage portion 58, and a flange portion 60.

The storage portion 58 includes a cavity for storage of the precursor material (not illustrated). The cavity of the storage portion extends in a depth direction 106 from the flange portion 60. Referring to FIGS. 4 and 5, the storage portion 56 is perforated by the injection head 38 to supply conditioned fluid into the capsule.

The storage portion 58 is formed from a paper-based material. The storage portion 58 has a thickness of 0.2 mm. The closing member 56 is formed from a paper-based material. The closing member 58 has a thickness of 0.15 mm or 2-30 mm.

As used herein “paper based” may refer to as being formed at least partially from a thin sheet material produced by mechanically or chemically processing cellulose fibres derived from one or more of: wood; rags; grasses, or; other vegetable sources, in water, draining the water through fine mesh leaving the fibre evenly distributed on the surface, followed by pressing and drying.

The closing member 56 closes and may hermitically seal the storage portion 58 and comprises a flexible membrane. Referring to FIGS. 4 and 5, the closing member 56 is perorated to eject the beverage/foodstuff.

The flange portion 60 is formed integrally with the storage portion. The flange portion 60 is arranged at the junction of the storage portion 58 and closing member 56 and comprise a planar extension of the storage portion 58 that is overlapped by a portion of the closing member that is fixed thereto to hermetically seal the precursor material. The flange portion 60 extends in a plane defined by a lateral direction 102 and a longitudinal direction 100. Hence the closing member is planar in said plane.

The capsule 6 is circular cross sections such that it is rotationally symmetric about axis 108. In this way a user can present the capsule to the machine 2 with any orientation about the axis 108. The capsule 6 has a diameter of 53 mm, which is measured across an outer or inner periphery of the flange portion 60 in said plane of the flange portion 60. The capsule 6 can be configured with different sizes, which are characterised by different depths e.g.: 7 mm; 12 mm; 15 mm; 18 mm, and; 21 mm.

In variant embodiments, which are not illustrated, the closing member may be arranged as convex or concave with respect to the storage portion. For example, for a convex arrangement, a centre of the closing member may extend into the storage portion in the depth direction by up to 1 mm ±10% or 20%. A minimum concavity maybe 0.2 mm. For example, for a concave arrangement, a centre of the closing member may extend away from the storage portion in the counter depth direction by up to 4 mm ±10% or 20%. A minimum concavity maybe 0.5 mm.

In variant embodiments, which are not illustrated: the body portion comprises the flange portion formed non-integrally with the storage portion and connected thereto; the body portion comprises the flange portion omitted, e.g. the closing member is wrapped around the storage portion; the container may be a non-rotationally symmetric shape, e.g. square sectioned or other shape; the capsule is alternatively dimensioned, including across an outer or inner periphery of the flange portion is 40-70 mm or 53 mm ±10% or 20% and the depth is any of the described depths ±10% or 20%; the thickness of the storage portion may have a thickness of 0.1 to 0.4 mm or 0.2 ±20% or 30%; the thickness of the closing member may have a thickness of 0.05 to 0.3 mm or 0.15 ±20% or 30%, and; the storage portion and/or closing member may be made out of or include a different material, e.g. including a plastics or aluminium based material.

### Arrangement of Code

Referring to FIG. 7, the code 44 code may be arranged on an exterior surface of the container 6 in any suitable position such that it can be read by the code reading system 18.

In an first example, the code 44 is arranged at a central region of the closing member 56. The code can therefore be read by any code reader that is aligned to the centre of the container. In an second example, the code is reproduced over the entire closing member so that it can be read from any exterior position on the closing member 56. With such an arrangement the closing member does not require any specific alignment with the storage portion, which simplifies cutting and assembly processes for the container 6.

In variant embodiments, which are not illustrated, the code can be arranged on the flange portion 60 (including on either side) and on the storage portion 58. The code may also be arranged on the closing member but not on the central region.

### Process for Preparing Beverage

Referring to FIG. 8, a process for preparing a beverage/foodstuff from precursor material is illustrated:

### Block 70: a User Supplies a Container 6 to the Machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.
Block 74: the electrical circuitry 16 controls the processing unit 14 to process the container (e.g. in the first example of the container processing unit 20, the extraction unit 32 is moved from the capsule receiving position (FIG. 4) to the capsule extraction position (FIG. 5)).
Block 76: the electrical circuitry 16 controls the code reading system 18 to provide a digital image of the code 6 of the container.
Block 78: the code processing circuitry of the electrical circuitry 16 processes the digital image to extract the preparation information.
Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion through the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### Code General Description

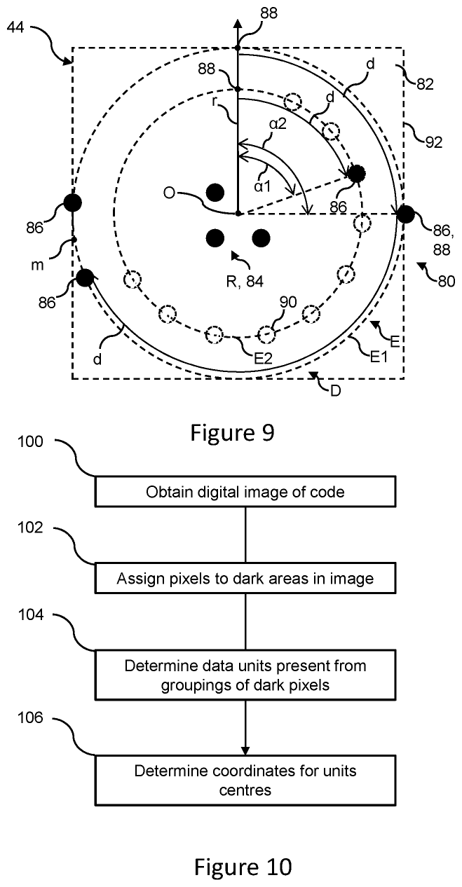

Referring to FIG. 9, the code 44 is formed of a plurality of circular units 80 arranged on a surround 82. The units 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween.

The units 80 are circular in shape. As used herein the term “shape” in respect of the units may refer to an exact shape or an approximation of the actual shape, which can occur to a printing or other manufacturing variations in precision.

In variant embodiments, which are not illustrated: the units are a light colour and the surround is a dark colour; the units have a different shape including one or a combination of the following shapes, triangular, polygon, in particular a quadrilateral such as square or parallelogram; other suitable shape.

The units 80 typically have a unit length of 50-200 μm. As used herein the term “unit length” in respect of a unit 80 may refer to a suitably defined distance of the unit 80, e.g.: for a circular shape the diameter; for a square a side length; for a polygon a distance between opposing or adjacent vertices; for a triangle a hypotenuse. The units 80 are arranged with a precision of about 1 μm.

The units 80 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 80-120 μm.

### Code Generic Organisation

Referring further to FIG. 9, the units 80 are organised into a reference portion R (also referred to as s reference portion) to locate and determine an orientation of the code 44 and a data portion D to store the preparation information.

The units 80 of the code 44, which are arranged as the reference portion R, comprise three reference units 84. The reference units 84 have a unique spatial arrangement in the code 44 to allow the reference portion R to be identified by the electrical circuitry 16 (e.g. with a stored relationship on a memory thereof) in the digital image. The unique spatial arrangement comprises the reference units 84 arrange at three of the vertices of a virtual rectangle (not illustrated), about an origin O at the centre of the rectangle, with specific distances between the reference units 84.

In variant embodiments, which are not illustrated, the reference portion is alternatively implemented, including: as a different arrangement of reference units, e.g. including as a circle or other shape of rectangle; with a different number of reference units, e.g. including as 4 or 5, and; the reference units may have a unique shape that is identifiable from the shape of the other units forming the code.

The arrangement of the reference units 84 enables the definition of a single reference line r at a specific vector relative to said units 84. The reference line r is virtual, and is determined by the electrical circuitry 16 (e.g. with a stored relationship on a memory thereof).

In the particular example, the reference units 84 define, using the right hand rule, a first virtual line (not illustrated) and a second virtual line (not illustrated), wherein: the thumb represents the first virtual line which intersects the centres of two of the refence units 84; the index finger represents the second virtual line which intersects the centres of two of the refence units, one of which being the common to the first virtual line; the second finger is into the plane of the page of the code 44. The reference line r extends from the origin O and is parallel to the first virtual line and is orthogonal to the second virtual line.

In variant embodiments, which are not illustrated, the reference line may be alternatively defined: the may comprise an actual line drawn on the code; it may have an alternative geometric arrangement with respect to the reference units.

Units 80 of the code 44, which are arranged as the data portion D, comprise data units 86. The data units 86 are arranged on an encoding line E that intersects the reference line r. The encoding line E is virtual and is determined by electrical circuitry 16, (e.g. the encoding lines have predefined radii, which are stored on a memory thereof). The centre of the circle of the encoding line E is arranged at the origin O of the reference portion R. The reference line r therefore intersects the encoding line E with a tangent thereto orthogonal to the reference line r. There are two encoding lines E1, E2, each with data units 86.

In variant embodiments, which are not illustrated: other numbers of encoding lines are implemented including 3, 4, or 5; the encoding lines may have non-circular shapes, including rectangular or triangular; the encoding line comprises an actual line drawn on the code.

The encoding line E includes one or more individual data portions, each of which includes a start position 88 and a data unit 86, which is arranged at a distance d along the encoding line E from the start position 88 as a variable to encode a parameter of the preparation information. The start positions 88 are defined virtually and may be determined by electrical circuitry 16 (e.g. the start positions may be stored on a memory thereof).

For the first encoding line E1, the data portion includes two individual data portions: for the first individual data portion the distance d can be any continuous distance from the start position 88 at the reference line r to the first data unit 86 clockwise from the reference line r; for the second individual data portion the distance d can be any continuous distance from the start position 88 at the data unit 86 of the first individual data portion (hence the start position is variable) to the mid-point m between the subsequent two data units 86 in the clockwise direction.

For the second encoding line E2, the data portion includes one individual data portion, for which the distance d can be any one of a plurality of discrete distances, which are illustrated as discrete positions 90 from the start position 88 at the reference line r, with each position associated with a value of the parameter. In the example there are 10 discrete positions 90.

In variant embodiments, which are not illustrated: a start position can be arranged at any position on the encoding line, including spaced away from the reference line; there may be multiple start positions on an encoding line, each with an associated data unit; the start position may be formed as part of the code as a unit rather than defined virtually; an encoding line may comprise combinations of parameters encoded by the continuous distance and the discreet positions; more than one or two data units on the encoding line may define the parameter, which can be determined as an average of the positions, and; the data portion can include any suitable number of individual data portions.

The code 44 includes an outer periphery 92 that the units 80 are arranged within. The outer periphery 92 is rectangular in shape and has a characteristic dimension of 600 -1600 μm, or about 1100 μm. The code 44 may be repeated such that multiple repetitions of the code 44 are arranged within a single digital image, such that one or several best captured repetitions of the code can be selected for processing.

In variant embodiments, which are not illustrated: the outer periphery may be alternatively shaped, including circular; the outer periphery may have alternative sizes, including greater or smaller than the example range.

In variant embodiments, which are not illustrated, the data portion alternatively encodes the value of said parameter, including as alphanumeric symbols or other arrangement.

Referring to FIG. 10, with reference to the code of FIG. 9, a code processing process, which is executed by the electrical circuitry 16 (or the code processing circuitry thereof) for extraction of the preparation information includes:

### Step 1—Identify Locations of Units of Code

Block 100: obtain digital image of code 44 via the code reading system 118.
Block 102: assign pixels to dark areas in digital image that could represent units 80.
Block 104: if several units in proximity of each other then determine a unit 80 as present.
Block 106: for each determined unit determine a centre of pixel grouping by a rule, e.g. feature extraction, to determine a coordinate of a centre of the unit.

Invariant embodiments, which are not illustrated, alternative processing techniques for determining units and there coordinates may be implemented, including other techniques for locating a centre of a unit or identifying a unit as present, e.g. a level of magnification may be implemented so that a single pixel is determined as a unit, and a centre of a unit may be determined as the centre of a pixel.

### Step 2—Locate Reference Portion and Read Angles of Code

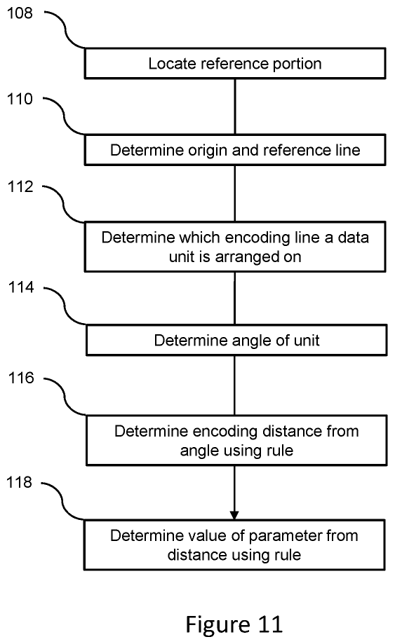

Referring to FIG. 11, with reference to the code of FIG. 9, processing of the code 44 includes:
Block 108: locate reference portion R by searching coordinates of units 80 of code 44 to identify the unique separation and geometric arrangement of reference units 84. This may be implemented by geometric rules including Pythagoras and trigonometry or other suitable rule. Said separation and geometric arrangement can be stored on the electrical circuitry 16 and accessed during searching.
Block 110: for the located reference portion R, define the origin O and the position of reference line r using a stored relationship. The arrangement of the origin and reference line can be stored on the electrical circuitry 16 and mapped onto the coordinates of the located reference portion.
Block 112: for each unit (other than the units of the reference portion) determine based on distance from the origin O which encoding line E the units belong to. The electrical circuitry 16 can store a radii range for each encoding line E and using geometric rules determine the distance of each unit from the origin O and which radii range it falls in.
Block 114: for each unit (other than the units of the reference portion) determine the angle α1, α2 with respect to the reference line r. It is to be noted that the angle is representative of the circumferential distance, and either could be used interchangeably. The angle can be calculated via know geometric relations between the coordinates of the reference line r and a virtual line extending from the origin O and through the associated unit.

### Step 3—Determine Values of Parameters of Preparation Information

34

Referring to FIG. 11, with reference to the code of FIG. 9 processing of the code 44 includes:
Block 116: the encoding distance d is determined for each individual data portion. This is achieved by implementing a set of rules for determining the encoding distance d which are stored by the electrical circuitry 16. This can include the one or more of: the number of individual data portions on each encoding line; the start positions 88 of the individual data portions; if a single unit or multiple units represent a data unit 86, and; other suitable relationships.

For example referring to FIG. 9, the rules for determining the encoding distances d of encoding line E1 include that there are: two individual data portions; the start position 88 of the first individual data portion is at the intersection between the reference line r and the encoding line E1; the start position 88 of the second individual data portion is at the data unit 86 of the first individual data portion; the data unit 86 is of the first individual data portion is represented as a single unit of the code 44; the data unit 86 is of the second individual data portion is represented as a two units of the code 44.

For example, referring to FIG. 9, the rules for determining the encoding distance d of encoding line E2 include that there is: a single individual data portion; the start position 88 is at the intersection between the reference line r and the encoding line E2; the data unit 86 is of the first individual data portion is represented as a single unit of the code 44.
Block 118: the encoding distances d for each data portion are converted into a value of a parameter. This is achieved by implementing a set of rules for converting the distance of a value which are stored by the electrical circuitry 16.

For example, for encoding line E1: the first individual data portion may encode a water volume of a brewing process wherein the distance d is any continuous value which is linearly related to the water volume, and; the second individual data portion may encode a time of a brewing process wherein the encoding distance d is any continuous value which is exponentially related to the time.

For example, for encoding line E2: the single individual data portion may encode a water temperature of a brewing process wherein the encoding distance d is a discrete value which incrementally changes by 5 degrees C for each discrete position 90, and the rule specifies which 5 degree increment is closest to the determined encoding distance d.

In variant embodiments, which are not illustrated, other rules can be implemented, including: other mathematical functions relating the encoding distance to the value of the parameter, and; if an encoding distance is the average of the distance several individual data portions, and other suitable relationships.

### Closing Member

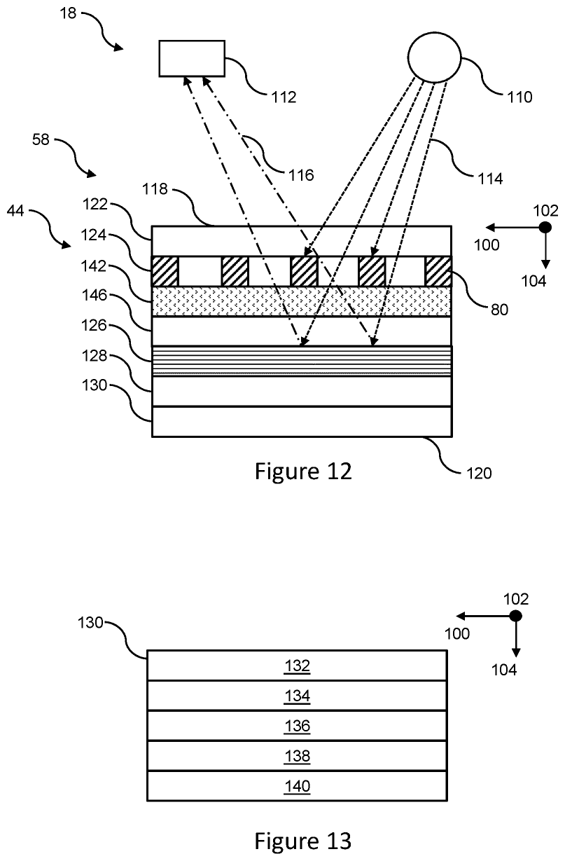

Referring to FIG. 12, there is provided a first example of the closing member 56 comprising the code 44. The code 44 is formed integrally within the layers of the closing member 56, as will be discussed. The code 44 is arranged as discussed in association with FIG. 9, and is arranged as identical repetitions over the closing member 56 so that any one code is readable to obtain the preparation information. In variant embodiments, which are not illustrated, other codes may be used e.g. a barcode and there may only be a single repetition of the code.

The code reading system 18 comprises the lighting system 110 and the camera system 112. The lighting system 110 emits a projected emission 114 onto the closing member 56. The camera system 112 obtains a digital image of the code 44 (an example of which is shown in FIG. 9) from a reflected emission 116, as will be discussed.

The projected emission 114 from the lighting system 110 is substantially in the infra-red wavelengths, e.g. a wavelength of greater than 700 nm or 800 nm. The emission may have a peak of any value between 800-1000 nm, with a HWHM of ±100 or 50 or 25 nm of the peak value. In an example the peak value is 850 nm and the HWHM is ±30 nm.

The camera system 112 is correspondingly configured to obtain said digital image within said wavebands. This may be achieved by the implementation of a filter, that passes frequencies above 800 nm or 700 nm or other suitable value selected to remove any interfering wavelengths from the information carrier layer and colour layer, as will be discussed.

The closing member 56 is planar and extends in the longitudinal direction 100 and lateral direction 102 with a depth direction 104 that extends in the through thickness from an outer surface 118 that faces away from the storage portion 58 (illustrated in FIG. 7) to an inner surface 120 that faces the precursor material (not illustrated in FIG. 12), which is stored in the storage portion. Although the closing member 56 is illustrated as planar, it may be flexible, and may therefore take various forms based on how its is connected to the body portion 62 (illustrated in FIG. 7).

### Protective Layer

The closing member 56 comprises a protective layer 122 through which the code 44 is readable by the code reading system 18. An outer surface of the protective layer 122 is arranged as the outer surface 118. The protective layer 120 provides a food safe barrier and also protective cover to the code 44. The protective layer 110 is formed of regenerated cellulose. The protective layer 110 is 22 microns in thickness. The protective layer has a transparency of at least 80% to the projected emission 114 and reflected emission 116, which is selected to enable reading of the code 44 through the protective layer 122.

The protective layer 122 can be implemented with a matte finish, e.g. for diffuse light reflection. An example includes a matte lacquer.

In variant embodiments, which are not illustrated, the protective layer is alternatively formed of other materials including one or more of: sulpack white from Ahlstrom-Munksjö; semi-transparent papers including parchment paper or super calendered papers; semi-transparent plastics including PLA, PET, PE and PP; the protective layer may have alternative thickness, e.g. 5-50 microns, and; the protective layer may also be omitted.

### Absorber Layer

The code 44 comprises an absorber layer 124, which is configured to absorb the projected emission 114 and a reflector layer 126, which is configured to reflect the said emission 114 as the reflected emission 116. The code 44 is supported by a support layer 128, which is substantially transparent to the projected emission 116. The reflector layer 126 is arranged to reflect the emission before it is transmitted to the support layer 128, as will be discussed.

The absorber layer 124 is arranged in the depth direction 104 between the reflector layer 126 and the outer surface 118, such that the absorber layer 124 is proximal most the outer surface 118 relative to the reflector layer 126 and the reflector layer 126 is arranged in the depth direction 104 between the support layer 128 and the outer surface 118.

The absorber layer 124 comprises a formation of the units 80 (shown in FIG. 9) that together form individual repetitions of the code 44. The absorber layer 124 has a reflectance of less than 10% and an absorbance of at least 80% or 90%.

The units 80 are formed of ink with a carbon black colour pigment, hence the absorber layer 124 absorbs all wavelengths of the visible spectrum, e.g. 390 nm-700 nm (as well as those of the projected emission 114), hence it is desirable to conceal the absorber layer 124 as will be discussed. The absorber layer 124 is 1-5 microns in thickness. The ink is selected to be biodegradable as defined herein.

In variant embodiments, which are not illustrated, the absorber layer is alternatively formed: a non-carbon based pigment is used, which can include other relatively dark colours such as dark blue; dark purple; dark green; the units are alternatively formed from solid pieces of material rather than with an ink.

The reflector layer 126 is continuous at a depth below said formation of units 80 that comprise the absorber layer 124. With such an arrangement, a portion of the projected emission 114 that passes through the gaps between the units 80 of the absorber layer 124 is reflected from the reflector layer 126 and back through said gaps in the absorber layer 126 as the reflected emission 116.

### Reflector Layer

The reflector layer 126 is configured to diffusively reflect the projected emission 114 as the reflected emission 116. The reflector layer 126 has a reflectance to the emission of at least 70% and an absorbance and/or transparency to the emission of less than 30% or 20%.

The reflector layer 126 is formed of ink with a titanium dioxide (TiO2) based white colour pigment. The reflector layer 126 diffusively reflects all wavelengths of the visible spectrum, e.g. 390 nm-700 nm (as well as those of the projected emission 114), hence it presents as being white when viewed by a user. The reflector layer 126 is 1-5 microns in thickness. The ink is selected to be biodegradable as defined herein.

The reflector layer 126 is connected the support layer 128, e.g. by a connecting layer (which can be as discussed for the barrier layer) layer such that it adjoins support layer.

The reflector layer 126 is arranged to overlap the entire the support layer 128 when viewed in the plane defined by the longitudinal direction 100 and lateral direction 102. In this way it is ensured that minimal/no projected emissions 114 travel through the support layer 128.

In variant embodiments, which are not illustrated, the reflector layer is alternatively formed: a non-titanium oxide based pigment is used, which can include other relatively light colours such as white; light blue; yellow; light green; the reflector layer is alternatively formed from one or more solid pieces of material with the same optical properties rather than with ink; the reflector layer is not continuous, e.g.: the reflector layer is formed as discrete portions, which may be arranged in a depth direction below the absorber layer, or at the same depth as the absorber layer but between the units, or combinations of said arrangement, with the functional arrangement that the reflector layer reflects emissions that pass between the gaps of the units of the absorber layer, and; the reflector layer is arranged to form the units of the code and the absorber is arranged to absorb the emission between the units, in such an example for FIG. 12 the reflector and absorber layers would be swapped in position.

### Support Layer

The support layer 128 is configured to provide the main structural support for the closing member 56. For example, at least 70% or 80% or 90% of a tensile strength of the closing member 56 may be provided by the support layer 128.

The closing member 56 is selected to comply with a penetration test criteria.

In an embodiment, the test criteria comprises: the closing member 56 configured to be penetrable (so that it is fully perforated in the depth direction to create a through hole) by a one or more penetrators when subject to a force of greater than a threshold.

The specification of the penetrators is: a tip portion angled at 70-30 degrees to taper outwards from a point of penetration, which occurs at an apex of the tip portion; the penetrator is circular in cross section (in a lateral and longitudinal plane); the tip portion has a full round applied at the apex, with a radii selected to correspond to the tip angle; a base of the penetrator (e.g. distal the apex) has a diameter of 1.5 mm.

The threshold force is 7-10 N or 5-15 N per penetrator. Alternatively, the threshold is a total force of 700 N (±20% or ±30%) applied to all the penetrators, e.g. there may be a total of 88 or 50-150 penetrators.

This penetration criteria ensures that the closing member 58 is penetrable by the machine 2, whilst the closing member 58 is sufficiently impenetrable to prevent accidental penetration, e.g. during handling. Since the support layer 128 is the main structural support for the closing member 56, this criteria can be achieved by appropriate selection of the thickness of the support layer 128.

In the example, the support layer 128 comprises Kraft 60 gsm paper, which has a thickness of about 96 microns. It has been found that such a thickness range provides adequate structural support, whilst remaining conveniently penetrable by the machine 2. Paper produced from the Kraft process (e.g. with low lignin and less degradation of the cellulose) provides a paper with a comparatively high elasticity and high tear resistance compared to paper produced from conventional pulping processes. The support layer 128 is selected to be biodegradable as defined herein.

Due to the penetration and biodegradability requirements, the support layer 128 is transparent to at least 30-80% of the projected emission 114 from the lighting system 110.

In variant embodiments, which are not illustrated: the support layer has an alternative thickness, e.g. 50 to 150 microns or 75 to 125 microns of 2-50 microns; the support layer is formed of other materials e.g. aluminium and/or plastic based, including PET12u/Alu30/BOPP30; the support layer may be arranged as more than one layer, which together have the required strength/penetrability.

### Barrier Layer

Referring to FIGS. 12 and 13, the closing member 56 comprises a barrier layer 130, which comprises a laminate of: an inner cover layer 132; a connecting layer 134; a seal layer 136; a connecting layer 138, and; an outer cover layer 140.

The outer and inner layers 132, 140 are configured to prevent water penetration to the seal layer, and also the penetration of oils or like substances from the precursor material. The outer and inner layers 132, 140 comprise a biodegradable aliphatic polyester. Examples include one or more of: poly(butylene succinate) (PBS); polybutylene sebacate terephthalate (PBST); polyhdroxyalkanoate (PHA); polyhdroxybutyraat (PHB); poly(3-hydroxybutyrate-co-3-hdroxyhexanoate) (PHBH); poly(3-hydroxybutyrate-co-3-hydrovalerate) (PHBV); polycaprolactone (PCL); poly(lactic acid) (PLA); poly(glycolic acid) (PGA); polybutyleneadipate-terphthalate (PBAT). Other suitable constituents can include: poly(alkylene dicarboxylate); poly(lactic-co-glycolic acid) (PLGA); starch. An example is Ecovio, which comprises PBAT and PLA.

The connecting layers 134, 136 are configured to interconnect adjacent cover and seal layers. The connecting layers 134, 136 comprise biodegradable aliphatic polyester, e.g. one or more of PBS, PBAT and/or PBST. The thickness is 3 to 5 micrometres (um).

The seal layer 136 is configured to provide an oxygen barrier to improve shelf life of the container 6 by reducing an amount of oxygen transmittable through the closing ember 58 to the precursor material. The seal layer 136 comprises a vinyl alcohol polymer, including co-polymers. The vinyl alcohol polymer comprises: a highly amorphous vinyl alcohol polymer (HAVOH), including copolymers such as a butandiol vinyl alcohol co-polymer (BVOH). An example is referred to as G-Polymer.

In variant embodiments, which are not illustrated, alternative barrier layers can be implemented: there may be more than one seal layer; there is only one of the outer or inner layers, and; the barrier layer may be omitted.

A thickness of the barrier layer 120 is in the range of 20 to 125 pm. A thickness of the connecting layers is 124, 126 is micrometres (um). A thickness of the outer and inner layers 122, 130 is 20 to 50 pm. A thickness of the seal layer 126 is 1.5 to 10 pm. Such a thickness is selected so that the closing member 56 is penetrable by the previously described penetration test. Due to said thickness, the barrier layer 130 is transparent to the projected emission 114. The barrier layer 120 is selected to be biodegradable as defined herein.

The barrier layer 130 is connected to the support layer 128 by a connecting layer (not illustrated), which is as discussed above for the connecting layers 134, 136.

### Information Carrier Layer

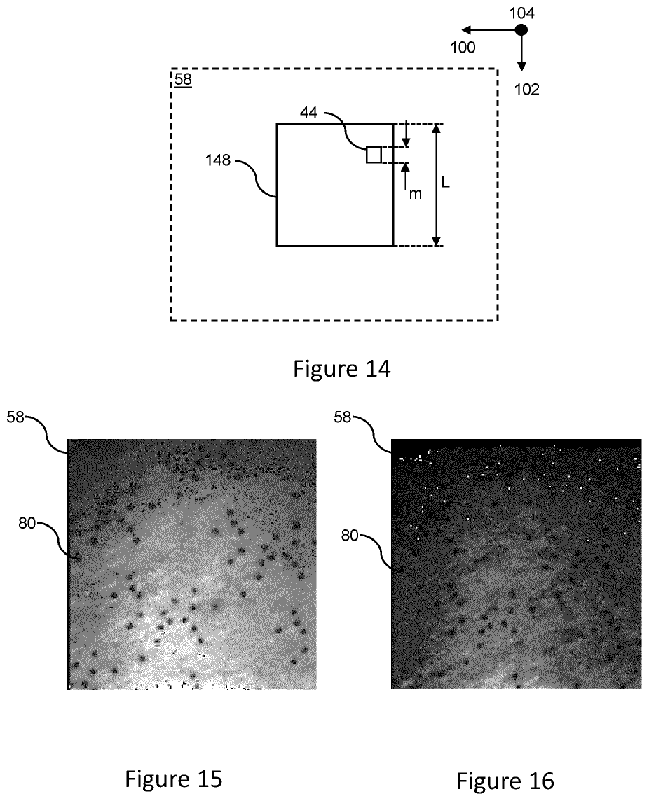

Referring to FIGS. 12 and 14, the closing member 56 comprises an information carrier layer 142. The information carrier layer 142 is configured to conceal the code 44 (compared to an embodiment without an information carrier layer 142) from a user when viewing the closing member 56 whilst displaying container information to a user. Said effect is achieved by: the operative positioning of the information carrier layer 142 relative the absorber layer 124 and the configuration of the reflector layer 126 and information carrier layer 58, as will be discussed.

Referring to FIG. 14, the information carrier layer 142 is configured to provide container information (as previously discussed) as one or more discrete objects 148 that are visible to a user, e.g. they are visible in the wavelengths 380-750 nm and are sized to be observable. The information carrier layer 142 is visible to a user through the protective layer 122 and the absorber layer 124.

Information carrier layer 142 has a comparatively low absorbance and reflectivity to the projected emission 114, such that it does not substantially interfere with reading of the code 44 in the previously described wavelengths. In embodiments, the information carrier layer has an absorbance to the emission of less than 20% and a reflectivity of less than 30% to said emission.

To enhance visibility of the objects of the information carrier layer 142, the reflector layer 126 is configured to diffusively reflect all visible wavelengths, e.g. it is visibly white (as well as those of the projected emission 114). In this way, the reflector layer 126 presents as a white luminous background over which the objects 148 of the information carrier layer 142 are superimposed.

The object 148 is configured to have a characteristic dimension L, which is typically a largest dimension of said object 148, e.g. L is a side length of a rectangle or diameter of a circle for a rectangular or circular object 148 respectively, or for other shaped objects said dimension for a rectangle or circle fitted around said object. The characteristic dimension L is greater than the previously discussed characteristic dimension m of the code 44. In embodiments L>a.m, wherein a=2 or 3 or 5, with a maximum of 10 or 20. In the example of the code 44 in FIG. 9, m is 600-1600 μm, and L is 4-15 mm.

With such a size relationship, its has been found that a user focuses on the larger length scales of the object 148 rather than the code 44.

In variant embodiments, which are not illustrated: the object is formed of a plurality of different colours (e.g. combinations of Cyan, Magenta and Yellow), to enable the carrying of further information and also enhance concealing of the code.

Since the code 44 and objects 148 are both present in the visible spectrum, the code 44 may not readable in visible wavelengths due to the presence of the information carrier layer 142 in the digital image. Such an arrangement may define the code 44 as being concealed.

The information carrier layer 142 is 1-5 microns in thickness. The information carrier layer 142 is formed of ink, and in particular ink that does not comprise carbon so as not to interfere with reading of the code 44 in the discussed wavelengths. The information carrier layer 142 is selected to be biodegradable as defined herein.

The information carrier layer 142 is fully overlapped by the reflector layer 126, and is arranged between the reflector layer 126 and the absorber layer 124. In this way the reflector layer 126 illuminates the entire information carrier layer 142.

The projected emission 114 projects through the information carrier layer 142 in the depth direction 104 and the reflected emission 116 projects through the information carrier layer 142 in the counter depth direction 104. The visible wave lengths are projected in the same manner as said emitted wavelengths, but with the wavelengths for the relevant colours absorbed by the information carrier layer 142.

The information carrier layer 142 fully overlaps the absorber layer 126. In this way the code 44 is effectively concealed. The absorber layer 126 is proximal most the outer surface 118 relative to the information carrier layer 142.

In variant embodiments, which are not illustrated: the information carrier layer is alternatively formed, e.g. from solid pieces of material rather than with ink; the information carrier layer is formed continuously over the reflector layer, e.g. rather than as discrete objects, and; the information carrier layer is omitted; the information carrier layer is alternatively arranged, including between the absorber layer and the outer surface or between the units of the absorber layer, or combinations of said arrangements.

### Colour Layer

Referring to FIG. 12, the closing member 56 comprises a colour layer 146, which is arranged to impart a background colour, e.g. brown, to the closing member 56. The colour layer 146 is implemented in combination with the information carrier layer 142 to apply a background colour to the associated objects 144.

The colour layer 146 is continuous and fully overlaps the reflector layer 128, and is arranged between the reflector layer 126 and the information carrier layer 142. In this way the reflector layer 126 illuminates the entire colour layer 146. The projected emission 114 projects through the information colour layer 146 in the depth direction 104 and the reflected emission 116 projects through the colour layer 146 in the counter depth direction 104. The visible wave lengths are projected in the same manner as the emitted wavelengths, but with the wavelengths for the relevant colours absorbed by the colour layer 146.

The colour layer 146 fully overlaps the absorber layer 126 and information carrier layer 142. In this way the code 44 is effectively concealed and colour is applied to the objects 144.

The colour layer has the same formation and transparency properties to the emission and visible light as the information carrier layer 142, which for brevity is not repeated.

In variant embodiments, which are not illustrated: the colour layer is alternatively formed, e.g. from solid pieces of material rather than with ink; the colour layer is formed in discrete positions over the reflector layer, e.g. at the location of the objects/and/or the absorber layer; the colour layer is omitted; the colour layer is alternatively arranged, including between the absorber layer and the outer surface or between the units of the absorber layer, or combinations of said arrangements.

### Results

Referring to FIG. 15, a digital image is shown, which is obtained by the camera system 112, of a laminate comprising all the layers of the closing member of the first example as shown in FIG. 12, but without the reflector layer 126. The image shows acceptable resolution between the units 80 of the code 44.

Referring to FIG. 16 the digital image is shown for the same laminate when placed over precursor material (not illustrated). It can be seen that the resolution between the units 80 of the code 44 is significantly reduced to a level that has been found to introduce reading errors.

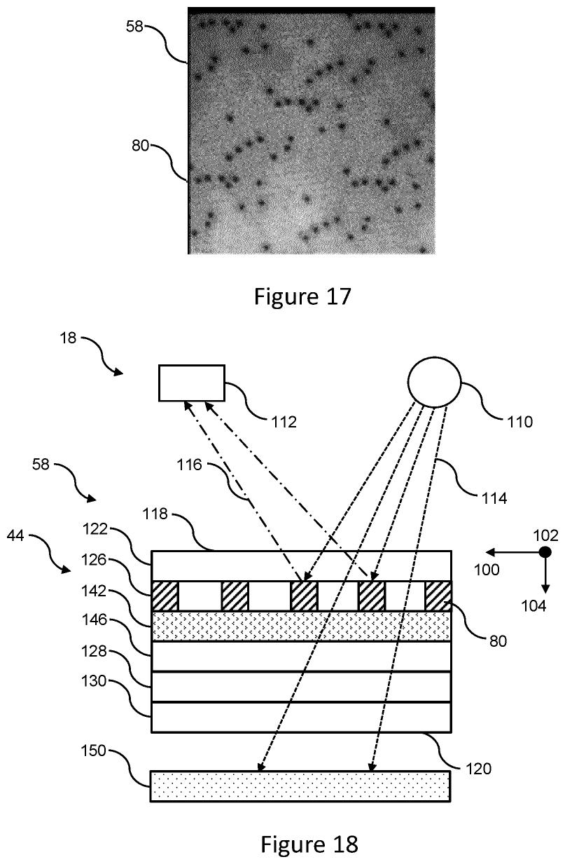

Referring to FIG. 17 a digital image for the closing member 56 of FIG. 12 is shown when arranged over the precursor material (which is the same as the laminate for FIGS. 13 and 14 but with the addition of the reflector layer 126). It can be seen that with inclusion of the reflector layer 126 the resolution between the units 80 is improved in comparison to the digital image of FIG. 14, and even that of FIG. 13.

### Precursor Material As Absorber Layer

Referring to FIG. 18, there is provided a second example of the closing member 56, which comprises the layers and associated variants as for the first example, but with the absorber layer omitted and the reflector layer 126 alternatively moved to the position of the absorber layer and forming the units 80 of the code 44.

The reflector layer 126 reflects the projected emission 114 as the reflected emission 116 to form the digital image of the code (not illustrated). The projected emission 114 therefore passes between the units formed by the reflector layer 126 and into the subsequent layers.

Without the reflector layer 126 to prevent the projected emission 114 projecting to the support layer 128, said emission is projected into and through the support layer 128 (and barrier layer 130), such that the projected emission 114 passes through the closing member 56. The projected emission 114 is projected into the storage portion 58 (see FIG. 7) and to precursor material 150.

The precursor material 150 functions as the absorber layer of the first example, which provides a dark background. The units 80 of the code 44 present as light units on the dark background since the reflector layer 126 diffusively reflects the emission.

The precursor material 150 is absorbent to at least 60% of the incident projected emission 114 from the lighting system 110. By implementing the precursor material to absorb most, e.g. above 50% or 70%, of the incident projected emission 114, the precursor material 150 provides a uniform, relatively dark background in the image.

The precursor material 150 comprises ground coffee. Ground coffee has been found to have a high absorbance of the selected wavelengths of the emission disclosed herein due to its high carbon content (similar to the ink that formed the absorber layer of the first example).

In variant embodiments, which are not illustrated: other precursor material may be used, e.g. tea; as for the first example, the reflector layer may be arranged at various positions in the closing member, including above below or between the information carrying layer and colour layer, the reflector layer may also be below the support layer.

### Specular Reflector As Support Layer

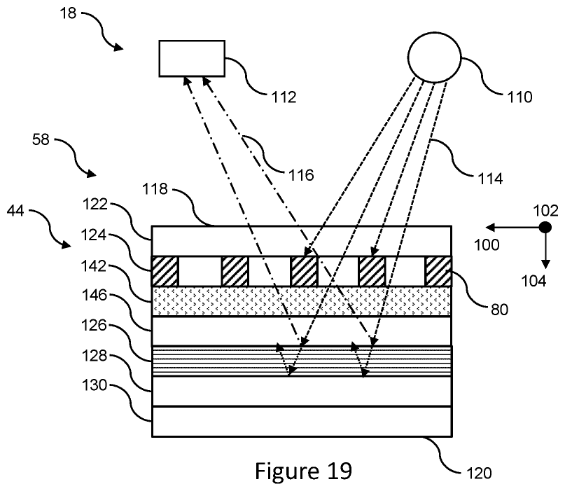

Referring to FIG. 19, there is provided a third example of the closing member 56, which comprises the layers and associated variants as for the first example, but with the support layer 128 alternatively configured for specular reflection of the incident projected emission 114 from the lighting system 110.

As discussed for the first example the code 44 comprises: the absorber layer 124, which is configured to absorb the emission 114 and the reflector layer 126, which is configured to diffusively reflect a portion of the emission 114. A portion of the emission 114 that travels though the reflector layer 126 is subject to specular reflection.

As discussed for the first example, the reflector layer 126 reflects a majority of the emission 144, e.g. reflectance to the emission of at least 70%, as the reflected emission 116. Since the reflective layer 116 is diffusively reflected the reflected emission comprises diffuse light. The transparency to the emission may be less 20% or 30% of the emission with an optional minimum transparency of 5% or 10%.

Any remainder of the emission 144 (which is not absorbed by the reflector layer 126) is transmitted through the reflector layer 126 to the support layer 128 where it is subject to specular reflection, which may aid in illuminating the code 44 and/or in providing a surface finish to the container which is observable through the code (e.g. a metallic finish for an aluminium support layer). Said specular reflection may subsequently be diffusely emitted from the reflector layer 126 (and/or be transmitted through the reflection layer as specular reflection).

With such an arrangement, the code 44 may be formed on support layers that are specular reflectors, which would otherwise reflect the emission 114 in a specular manner and cause saturation of the code reader due to the high intensity of the reflected emission. For example, the support layer 128 can have a reflectance of at least 70% or 90%, with the majority (e.g. at least 70% or 90%) of the emission reflected as specular. The support layer 128 may for example be implemented as aluminium or aluminium based, including and aluminium based polymer e.g. PET12u/Alu30/BOPP30.

In the first, second and third examples, and associated variants, the entire closing member 56 is optionally biodegradable. As used herein the term “biodegradable” may refer to composability as defined by EN 13432:2000 (including anaerobic conditions, disintegration etc) or EN 14046:2004 (aerobic conditions).

In the various embodiments, the material of the closing member 56 optionally has a total thickness of 100 to 250 microns or 150 to 200 microns. It has been found that such a thickness range provides adequate structural support, whilst remaining conveniently penetrable by the penetrator of the machine 2.

In variant embodiments, which are not illustrated, the above code and associated layers may be formed on: other components of the container, e.g. the storage portion; other containers, e.g. as a wall of a packet.

The protective layer 110, absorber layer 124, reflector layer 126, information carrier layer 142 and colour layer 146 are formed together as will be discussed and are connected to the support layer 128 by a connecting layer (not illustrated) as discussed above.

### Method of Forming Closing Member

Referring to FIG. 12, a process of forming the closing member 56 of the first example, comprises the following steps:
Step 1: the absorber layer 124 is printed on an interior side of the protective layer 122.

46
Step 2: the reflector layer 126, information carrier layer 142 and colour layer 146 are then subsequently printed over the absorber layer 124 and protective layer 110 obtained from Step 1 to form a printed laminate.
Step 3: the printed laminate from step 2 is bonded to a first side of the support layer 128 by a connecting layer (which is configured as discussed for the barrier layer).
Step 4: the barrier layer 130 is bonded to a second side of the support layer 128 by a connecting layer (which is configured as discussed for the barrier layer).
Step 5: the closing member 56 is cut from the printed laminate of step 4 by a cutting tool. A plurality of closing members 56 may be formed from the same printed laminate from anywhere on the laminate since the code is repeated across the entire laminate.

In variant embodiments: for steps 1 and 2 printing of the absorber and reflector layer can be completed concurrently, e.g. where the reflective layer is formed in the gaps of the units of the absorber layer; the absorber layer, reflector layer, information carrier layer and colour layer are printed on the support layer code layer and the laminate is bonded to the protective layer; steps 3 and 4 can be completed in any order or concurrently.

For the second example of the closing member, the layers are printed on the protective layer (or support layer) as for the first example, except the absorber layer is omitted. Said laminate is subsequently connected to the support layer, as for the first example.

For examples wherein the code is formed on other parts of the container, e.g. the body portion or a wall of a packet, the layers may be printed directly onto a wall thereof (which is typically a support layer) and an optional protective layer is be bonded to the printed layers.

### Method of Reading the Code

Referring to FIG. 10, and the associated preceding description, Block 100 (obtaining a digital image of the code) comprises for the first example of the closing member 58:
Step 1: projecting the projected emission 114 from the light source 110 of the code reading system 18 (see FIG. 18) through the protective layer 112 of the closing member 56.
Step 2: for said projected emission 114, absorbing a portion of the emission with the absorber layer 124 (or in the second example of the closing member 58, the precursor material 150) and reflecting a portion of the emission as the reflected emission 114 with the reflector layer 126.
Step 3: capturing a digital image of the code under the conditions of step 2.

The digital image from step 3 can then be processed to extract the preparation information as discussed for the code processing steps of FIGS. 10 and 11.

The container 6 can then be processed as discussed for the steps of FIG. 8, including steps perforating the closing member with a perforator of a beverage or foodstuff preparation machine and injecting fluid into a storage portion of the container containing precursor material.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Machine
14 Processing unit
20 Container processing unit (first example)
32 Extraction unit
34 Capsule holding portion
36 Closing portion
38 Injection head
40 Beverage outlet
22 Fluid conditioning system
24 Reservoir
26 Pump
28 Heat exchanger
30 Outlet
16 Electrical circuitry
48 Control electrical circuitry
50 Input unit
52 Processor
54 Feedback system
18 Code reading system
46 Image capturing unit
110 Lighting system
114 Projected emission
116 Reflected emission
112 Camera system
6 Container
56 Closing member
44 Code
80 Units
R Reference portion
84 Reference units
r Reference line
O Origin
D Data portion
86 Data units
E Encoding line
d Distance
88 Start position
90 Discrete positions
I Code Identifying portion
94 Discrete position
96 Identifying units
82 Surround
92 Outer periphery
118 Outer surface
120 Inner surface
122 Protective layer
44 Code
124 Absorber layer
126 Reflector layer
128 Support layer
130 Barrier layer
132 Inner cover layer
134 Connecting layer
136 Seal layer
138 Connecting layer
140 Outer cover layer
142 Information carrier layer
144 Object
146 Colour layer
58 Storage portion
150 Precursor material
60 Flange portion
124 Front surface
128 Rear surface
8 Server system
10 Peripheral device
12 Computer network

1. A container for use with a beverage or foodstuff preparation machine, the container comprising:
a storage portion for containing a precursor material;
a code for storing preparation information used by the machine to process the precursor material, the code configured to be readable by a code reading system of the machine, wherein the code reading system comprises: a lighting system to project an emission of greater than 700 nm to the code, and a camera system for obtaining a digital image of the code operating with a wavelength above 700 nm, the code is arranged to absorb and/or reflect the emission for capturing in a digital image by the camera system, and;
an information carrier layer comprising container information that is visible in visible wavelengths and configured to be readable by a user, and the information carrier layer has comparatively low absorbance and/or reflectivity to the emission,
wherein the information carrier layer is arranged in operative proximity to the code layer so that a positional arrangement of the information carrier layer and the code is such that the code is concealed or partly concealed by the information carrier layer, reducing the visibility of the code in the visible wavelengths compared to the code being present without the information carrier layer.

2. The container of claim 1, wherein the information carrier layer has an absorbance to the emission of less than 20% and a reflectivity of less than 30% to the emission.

3. The container of claim 1, wherein:
the information carrier layer is continuous;
the information carrier layer adjoins the code; and
the information carrier layer extends in a plane defined by lateral and longitudinal directions and has a through thickness in a depth direction, which extends from an outer surface, and wherein the information carrier layer is arranged to overlap the entire code when viewed in the plane.

4. The container of claim 3, wherein the code is proximal most the outer surface relative to the information carrier layer.

5. The container of claim 1, wherein the information carrier layer extends in a plane defined by lateral and longitudinal directions and has a through thickness in a depth direction; and
the code comprises an absorber layer, which is configured to absorb the emission, and a reflector layer, which is configured to reflect the emission;
the reflector layer is configured to reflect visible wavelengths;
the information carrier layer is arranged in a depth direction between the reflector layer and an outer surface of the closing member; and
the absorber layer is arranged in a depth direction between the reflector layer and an outer surface of the closing member.

6. The container of claim 5, wherein the reflector layer extends in a plane defined by the lateral and longitudinal directions and has a through thickness in a depth direction, and the reflector layer is continuous and overlaps the absorber layer in the plane.

7. The container of claim 1, wherein the information carrier layer comprises the one or more objects providing the information formed of one or more different colours.

8. The container of claim 5, wherein:
the absorber layer is formed of a black ink that comprises carbon; and
the information carrier layer and the reflector layers are formed of one or more inks that do not comprise carbon.

9. The container of claim 5, comprising a colour layer arranged to impart a background colour, wherein:
the colour layer is arranged in a depth direction between the reflector layer and an outer surface;
the colour layer is arranged in a depth direction between the reflector layer and the information carrier layer;
the colour layer is continuous;
the colour layer is formed of one or more inks that do not comprise carbon; and
the information colour layer is arranged to overlap the entire information carrier layer when viewed in the plane.

10. The container of claim 1, wherein the container is biodegradable.

11. A system comprising:
(i) a container comprising:
a storage portion for containing a precursor material:
a code for storing preparation information used by a beverage or foodstuff preparation machine to process the precursor material, the code configured to be readable by a code reading system of the machine, wherein the code reading system comprises: a lighting system to project an emission of greater than 700 nm to the code, and a camera system for obtaining a digital image of the code operating with a wavelength above 700 nm, the code is arranged to absorb and/or reflect the emission for capturing in a digital image by the camera system, and;
an information carrier layer comprising container information that is visible in visible wavelengths and configured to be readable by a user, and the information carrier layer has comparatively low absorbance and/or reflectivity to the emission,
wherein the information carrier layer is arranged in operative proximity to the code layer so that a positional arrangement of the information carrier layer and the code is such that the code is concealed or partly concealed by the information carrier layer, reducing the visibility of the code in the visible wavelengths compared to the code being present without the information carrier layer; and
(ii) the beverage or foodstuff preparation machine, which is configured for preparing a beverage or a foodstuff by processing the precursor material, the machine comprising:
a code reading system to read the code;
a processing unit for processing the precursor material of the container to the beverage or foodstuff, the processing unit comprising a perforator to perforate the closing member of the container; and
electrical circuitry to control the processing unit to process the container based on the preparation information.

12. A closing member for closing a storage portion of a container for use with a beverage or foodstuff preparation machine, the storage portion containing a precursor material, wherein the closing member comprises:
a code for storing preparation information used by the machine to process the precursor material, the code configured to be readable by a code reading system of the machine, wherein the code reading system comprises: a lighting system to project an emission of greater than 700 nm on to the code, and a camera system for obtaining a digital image of the code operating with a wavelength above 700 nm, the code is arranged to absorb and/or reflect the emission for capturing in a digital image by the camera system, and;
an information carrier layer comprising container information that is visible in visible wavelengths and configured to be readable by a user, and the information carrier layer has comparatively low absorbance and/or reflectivity to the emission,
wherein the information carrier layer is arranged in operative proximity to the code layer so that a positional arrangement of the information carrying layer and the code is such that the code is concealed or partly concealed by the information carrying layer, reducing the visibility of the code in the visible wavelengths compared to the code being present without the information carrying layer.

13. (canceled)

14. A method of forming a closing member for a container for use with a beverage or foodstuff preparation machine, the method comprising:
printing a code on a protective layer through which the code is readable by a code reading system, the protective layer is arranged to absorb and/or reflect the emission for capturing in a digital image by the camera system operating with a wavelength above 700 nm;
printing an information carrier layer on to the protective layer, wherein the information carrier layer is arranged so that a positional arrangement of the information carrier layer and the code is such that the code is concealed or partly concealed by the information carrier layer, the information carrier layer comprising container information that is visible in visible wavelengths and configured to be readable by a user, and the information carrier layer has comparatively low absorbance and/or reflectivity to the emission, such that the information carrier layer reduces the visibility of the code in the visible wavelengths compared to the code being present without the information carrier layer; and
bonding the protective layer and the information carrier layer to a support layer.

15. A method of reading preparation information from a code of a container containing precursor material, the method comprising:
absorbing and/or reflecting with a code an emission for a lighting system of a code reading system with a wavelength above 700 nm;
avoiding reflecting or absorbing the emission with an information carrier layer, the information carrier layer comprising container information that is visible in visible wavelengths;
obtaining a digital image of the code layer with a camera system operating above 700 nm; and
processing the digital image to extract the preparation information.

16. The method of claim 15, wherein the wavelength of the emission is above 800 nm.

17. The system of claim 11, wherein the wavelength of the emission is above 800 nm.
